(19) United States
(12) Patent Application Publication
(10) Pub. No.: US 2008/0202989 A1
(43) Pub. Date: Aug. 28, 2008

(54) Multi-Screener Sifting Apparatus

(76) Inventor: Francis X. Graney, Tewksbury, MA (US)

Correspondence Address: LAMBERT & ASSOCIATES, P.L.L.C., 92 STATE STREET, BOSTON, MA, 02109-2004, US

(21) Appl. No.: 12/037,159

(22) Filed: Feb. 26, 2008

Related U.S. Application Data
(60) Provisional application No. 60/903,668, filed on Feb. 27, 2007.

(51) Int. Cl. B07B 1/28; B07B 1/00

(52) U.S. Cl. 209/311; 209/233; 209/404

(57) ABSTRACT

A multi-screener apparatus in which the height of the apparatus may be adjusted for the convenience of a user. This multi-screener apparatus prevents the unwanted movement of the apparatus frame without the addition of counterweights or excessive frame mass to prevent the unwanted movement. Also, this multi-screener design may function with a variety of power sources, including electrical and fossil fuel based power sources. The unit is easily placed in a desired location by optional vehicle attachment means for towing as well as gripping handles and wheels for manually positioning the apparatus in a desired location. Further, the lightweight design of the apparatus also plays an important role regarding the mobility of the apparatus.

### FIELD OF THE INVENTION

The present invention relates generally to screening machines that separate substantially granular materials from other more volumous materials, within and about said granular materials. Materials commonly separated by machines of this field include rocks, roots, woods, bones, twigs, debris, and other materials of higher granularity then a specific tolerance selected at the time of operation.

### REFERENCES

In general within the art, descriptions of screeners and sifters are found in U.S. Pat. No. 6,315,129 set forth by Graney.

### BACKGROUND OF INVENTION

Screening apparatuses “screeners” have been used for centuries as a means of separating desirable and undesirable items from finer granular materials that obscured these items. Over time these systems have been used in numerous settings and jobs including gardens, municipalities, arson investigation scenes, violent crime investigation scenes, greenhouses and prospecting for precious metals and gems, to name a few.

In their early forms, screeners were often designed to be hand held, small in size and carried. Screeners quickly increased in size to carry larger amounts of granular material to ‘screen’ or ‘sift’. As sizes increased, more power was required in order to perform the to-and-fro movement critical to maintain a steady flow of granular material passing through the screens. Early power sources typically included more man and/or animal power, but over time evolved into gas, electric and other more modern power sources. However, technical obstacles had to be overcome.

In early self-powered screener designs, vibration was a critical weakness. The motors utilized caused the back and forth motion required to maintain granular material passing through the screens, but the entire screener itself would often move. This undesired motion could lead to the screener machine steadily moving away from its original location and the require constant repositioning. In more violent instances, vibration could lead to the machine itself falling on its side, losing the materials placed within it and potentially damaging the machine itself or even people.

The problem of this violent movement was solved in improved designs by the use of a counterweight mounted to the screener frame. With this counterweight, the back-and-forth motion required by the screens themselves that was transferred to the units frame, was marginalized or stopped completely. While this marked a major advance met in the art of self-powered screeners, operation was still less then ideal. The use of the massive counterweights and/or massive frame weights invariably led to extreme increases in the overall weight of the machines. This increase in weight made the machines cumbersome to relocate within a room, or to transport from worksite to worksite.

What is needed is a light weight, mobile, multi-purpose screening apparatus that can be quickly setup, in, virtually any location, that prevent the haphazard back-and-forth motion that plagued the early self-powered screening machines. The present invention provides a solution to all these shortcomings.

### SUMMARY OF THE INVENTION

The instant invention, as illustrated herein, is clearly not anticipated, rendered obvious, or even present in any of the prior art mechanisms, either alone or in any combination thereof. A light weight, mobile, multi-purpose screening apparatus designed to overcome the previously mentioned shortcomings of earlier problems in the art would afford user the advantages of easily relocating the device at an individual worksite and also easily moving the device from one worksite to the next, with minimal effort. Thus, the several embodiments of the instant invention are illustrated herein.

Therefore, it is an object of the present invention to overcome the previously mentioned shortcomings found in the prior art with an improved light-weight multi-screen apparatus.

Another object of the present invention is to provide a mobile and portable light-weight multi-screen apparatus.

Another object of the present invention is to provide a stable light-weight multi-screen apparatus.

Another object of the present invention is to provide a light-weight multi-screen apparatus that is capable of sifting and separating objects of variously granulated substances.

Another object of the present invention is to provide a light-weight multi-screen apparatus that uses an electrical power source.

Another object of the present invention is to provide a light-weight multi-screen apparatus that uses a petroleum based power source.

Another object of the present invention is to provide a light-weight multi-screen apparatus that utilizes any means of powering a motor.

Another object of the present invention is to provide a light-weight multi-screen apparatus that utilizes a reciprocating motion to cancel out or significantly dampen unwanted frame movement.

Another object of the present invention is to provide a light-weight multi-screen apparatus that shuffles debris.

Another object of the present invention is to provide a light-weight multi-screen apparatus that does not bounce debris about the screen surface.

Another object of the present invention is to provide a light-weight multi-screen apparatus that does not require the use of coil springs to support the upper screen frame.

Another object of the present invention is to provide a light-weight multi-screen apparatus that provides a convenient means of debris removal/redirection.

Another object of the present invention is to provide a light-weight multi-screen apparatus that allows for adjustment of its vertical height.

Another object of the present invention is to provide a light-weight multi-screen apparatus that utilizes foldable gripping members.

Another object of the present invention is to reduce material costs in the construction of screening devices and also to reduce the amount of construction material used in the prior art to provide stabilizing weight to the device.

Another object of the present invention is to develop a multi-screener device in which the operation of said multi-screener device will be substantively unaffected by extreme disproportionate masses of material to be sifted located to one side of the sifting screen or screens.

These together with other objects of the invention, along with various features of novelty which characterize the invention, are pointed out with particularity in the claims, Detailed Description of the Embodiments Sections and drawings of this application, with all said sections adding to this disclosure.

### BRIEF DESCRIPTION OF THE DRAWINGS

FIG. 1 illustrates an isometric front view of the light-weight, mobile, multi-purpose screening apparatus. The component parts visible include, a main frame, a plurality of screen frame members, screen frame support members, vertical support members, vertical support locking members, cross brace members, a motor, a motor power cord, a motor support plate assembly, a debris chute, a belt cover guard baffle assembly, a foldable transport handle, circular mobility members, a dirt shield, two debris screen members.

FIG. 2 illustrates an isometric front view of the light-weight, mobile, multi-purpose screening apparatus with an exploded view of the dirt shield and the belt guard removed. The component parts detailed in FIG. 1 are illustrated along with a belt drive mechanism.

FIG. 3 illustrates an exploded isometric front view of the light-weight, mobile, multi-purpose screening apparatus. Additionally illustrated in FIG. 3 and absent from FIG. 1 and FIG. 2 are the screen frame support members, crank shaft cams, crank shaft connecting members, a drive shaft, spherical drive shaft members, a drive pulley member, an absorption member.

FIG. 4 illustrates an isometric front view of the light-weight, mobile, multi-purpose screening apparatus, with the screen frame removed.

FIG. 5 illustrates a top-down view of the crank shaft cam, crank shaft connection members, shaft connection spherical members, a drive shaft, and various securing members.

FIG. 6 illustrates a side view of a plurality of crank shaft cams, shaft connection spherical members, a drive shaft, and a shock absorption member.

FIG. 7 illustrates an isometric view of the motor, motor support plate assembly, motor pulley, drive pulley, drive belt and a partial view of the drive shaft.

### DETAILED DESCRIPTION OF THE DISCLOSED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention, such as multi-screener apparatuses that are not self powered, and that have alternative means of dimension adjustment to name but two such examples.

Presently, screener apparatuses have failed to provide an efficient means of automation that may free up the need for excessive counterweights and screener frame weights. This of course leads to a lack of mobility related to these screen apparatuses. While these previous attempts have successfully made progress by eliminating the unwanted movement of the screener apparatus frame, the cost was high in materials and mobility. Further, the extra weight used to stabilize the system increased cost in constructing the screener units themselves by requiring more construction materials.

The present invention solves all of these prior shortcomings by introducing a lightweight portable multi-screener device that has reduced weight but provides the requisite back-and-forth sifting motion, while preventing unwanted movement of the entire unit. In addition, with the allowed decreased weight of these screeners, it becomes practical to now render the screeners mobile for users by adding wheels or other comparable movement devices.

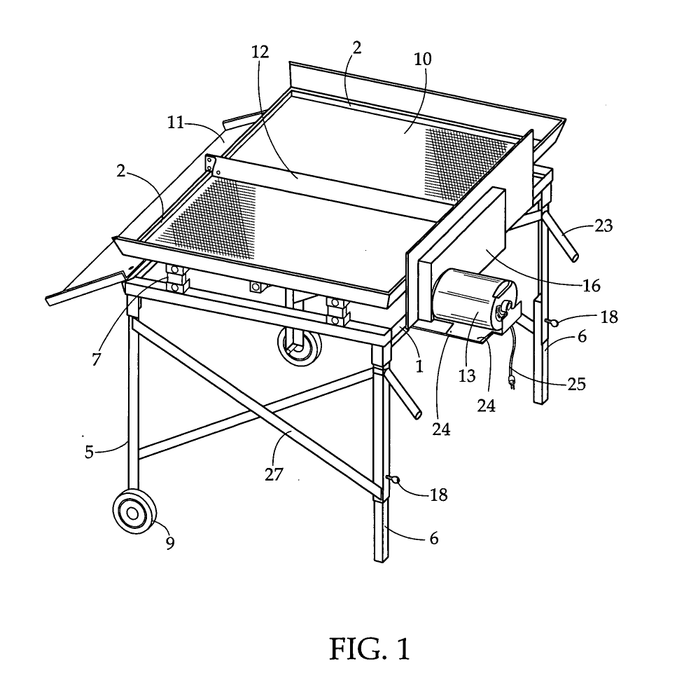

FIGS. 1-4 commonly show a front isometric view of the multi-screener sifting apparatus. Visible in these figures is the main frame 1 which is attached to four vertical support members 5, four screen frame support members 7, and a motor support plate assembly 24. Also, in common view in these figures are a motor 13 resting on said motor support plate assembly 24, foldable gripping members 23 attached to said vertical support members 5, a motor power cord 25 attached to said motor 13. Attached to or extending out of said vertical support members 7 are vertical height adjustment members 6 and circularly shaped movement members 9. To lock a selected vertical height adjustment member 6 in place there are two height locking members 18 protruding out of said vertical support members. Lastly, common to these figures are the cross support members 27, found attached to said vertical support members 7 in order to provide left-right stability to said vertical members 7.

In addition to the common features shown in FIGS. 1-4, FIGS. 1-3 also reveal a plurality of screen frame members 2, a screen 10 resting within said plurality of screen frame members 2 and substantially granular material shield 12 lying within said plurality of screen frame members 2 and bisecting said screen 10.

FIG. 1, in addition to the commonly disclosed features in FIGS. 1-4 and 1-3, also illustrates a belt cover assembly 16 attached to said motor support plate assembly 24 said motor 13, and a debris chute 11.

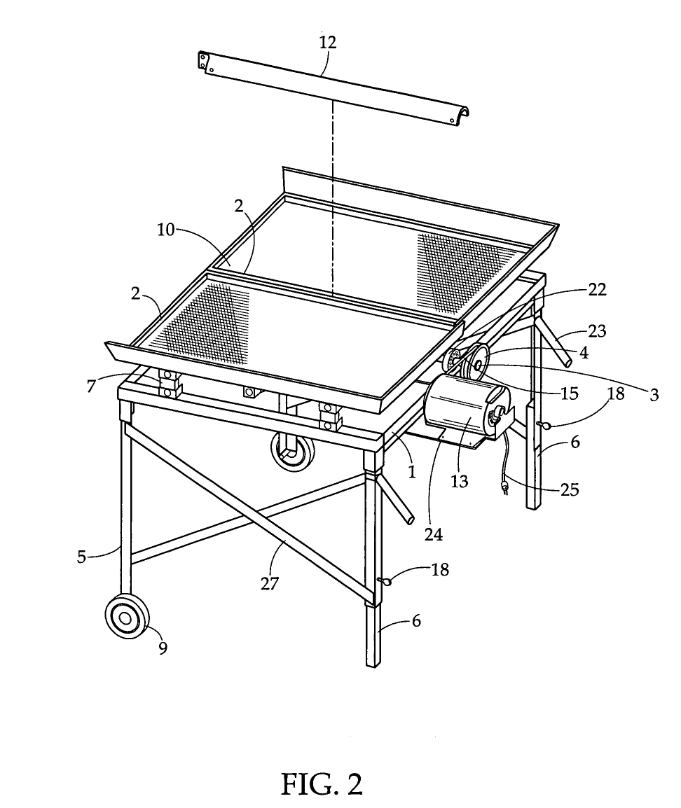

FIGS. 2-4 also commonly illustrate, in addition to any previously illustrated elements disclosed in the descriptions above, a ball bearing assembly 22 a pulley drive member 4 and a crank shaft member 3, with one end passing through said pulley drive member 4.

FIG. 2 also illustrates, in addition to any previously illustrated elements disclosed in the above descriptions, a pulley belt member 15 with one end about one end of said motor 13 and with a second end about said pulley drive member 4.

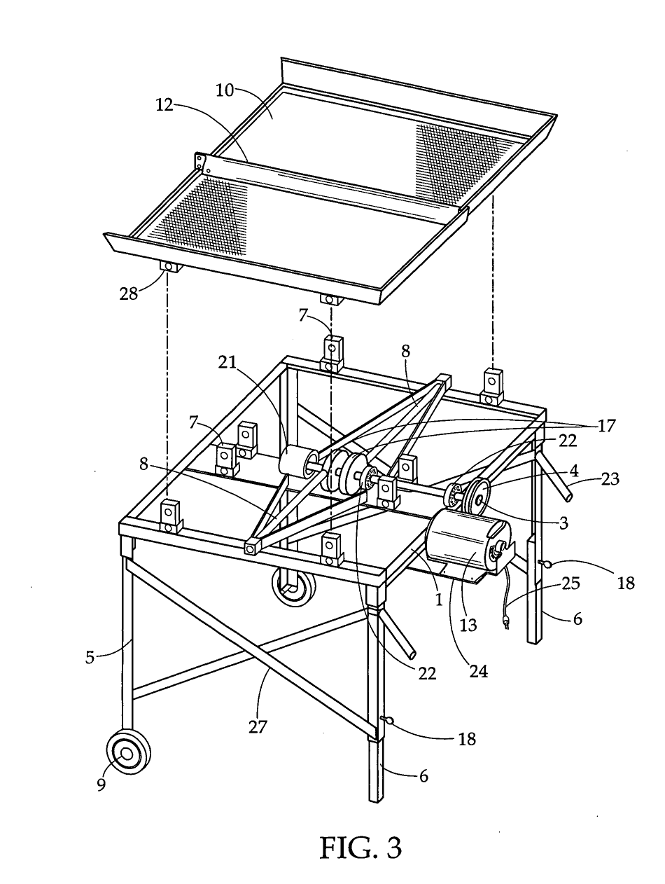

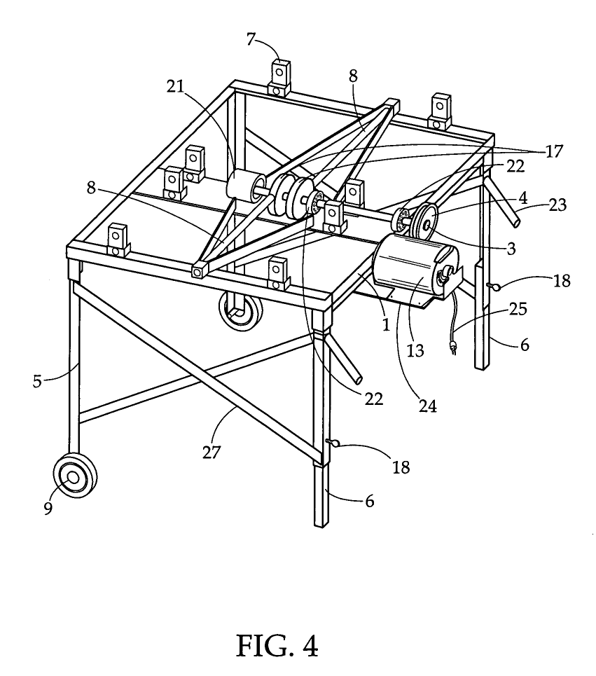

FIGS. 3-4 also illustrate, in addition to any previously illustrated elements disclosed in the above descriptions vertical support screen frame members 7 and ball bearing assembly members 22 that were hidden by the screen member 10 and said plurality of screen frame members 2. Further these figures commonly illustrate a shock absorption member 21, a plurality of crank shaft cam members 17 and a plurality of connecting members 8, connecting said cam members 17 to said main frame 1.

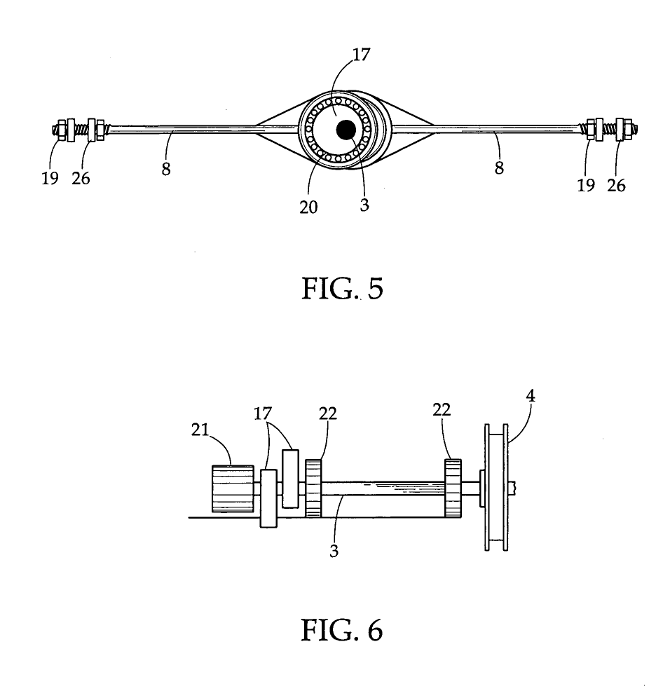

FIG. 5 illustrates a front-side view of the elements responsible for the back-and-forth sifting motion of the multi-screener apparatus. As illustrated, the drive shaft member 3 passes through crank shaft cam members 17 and the connecting rod ball bearing assembly 20. Further illustrated in this view are two connecting members 8 where one connecting member extends out of said connecting rod ball bearing assembly 20 and passes through a flexible spacing member 26 and a securing member 19.

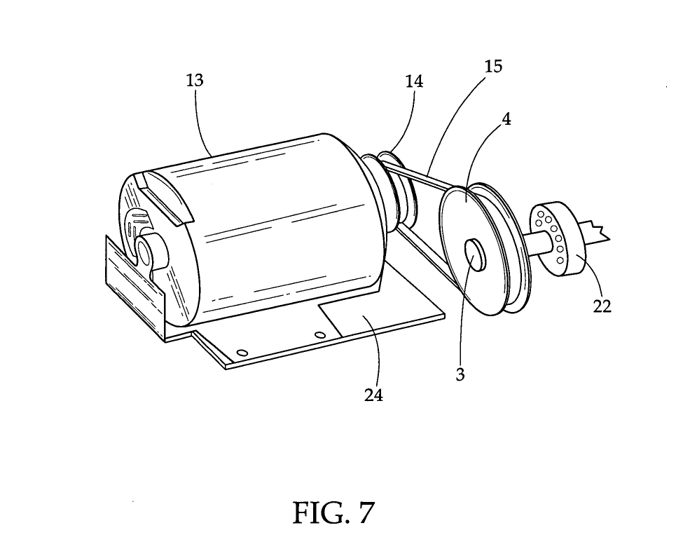

FIG. 6 illustrates a side view of the elements responsible for the back-and-forth sifting motion of the multi-screener apparatus. As illustrated, the drive shaft member 3 passes through a plurality of ball bearing assemblies 22, a plurality of crank shaft cam members 17 and a shock absorption member 21.

FIG. 7 illustrates an isometric side view of the motor 13 resting on said motor support plate assembly 24 along with the related power and motion source elements of the instant invention. As illustrated a motor pulley member 14 is attached to said motor 13 at one motor end. Positioned closely to one side of said motor pulley member 14 is a drive pulley member 4. Further illustrated, is a belt member 15 located adjacently about said motor pulley member 14 and drive pulley member 4. The crank shaft member 3 is illustrated as passing through said drive pulley member 4 and said ball bearing assembly 22.

Operation of the device is as such that when activated debris and substantially granular material placed on the screen 10 is vibrated back-and-forth without bouncing, allowing for finer granular material to pass through the screen 10 and downward below the apparatus. The material that did not pass through the screen 10 and downward consistently moves about the screen 10 until it passes to and then down the debris chute 11 in a substantially downward direction. The motion of the screen 10 is such that the sections of said screen 10 and the members of said plurality of screen frame members 2 move in opposite directions, thus substantially canceling out the vibrations to said apparatus main frame 1, thus allowing said apparatus to remain stable.

When users wished to move the multi-screener apparatus they may grab the foldable transport handle members 24, then lifting the said apparatus by said handles 24 and moving the apparatus along the substantially horizontal surface it rests upon by means of its circularly shaped movement members 9.

To adjust the vertical height of the multi-screener, a user should first remove both height locking members 18, then raise or lower the vertical support members 5 about the height adjustment members 6 until reaching a desired position. Once the apparatus is in the desired position the user may then insert the height locking members 18 through the vertical support members 5 and the height adjustment members 6.

What is claimed is:

1. A sifting apparatus comprising:
a main frame;
a plurality of screen frame members;
a debris sifting and removal system; and
a screen motion generation system.

2. The sifting apparatus of claim 1, wherein said debris sifting and removal system further comprises:
a plurality of screen members removably attached at a set of edges, to at least one member selected from said plurality of screen frame members, so that said screen member lies over, but not adjacent to the surface of said selected screen frame member;
a debris screen substantially perpendicular and removably attached to said surface of said screen frame;
a debris redirection member attached to said main frame; and
a plurality of screen frame vertical support members removably attached to at least one member of said plurality of screen frame members at a first end and wherein said screen frame vertical support members are attached to said main frame at a second end.

3. The sifting apparatus of claim 2, wherein said screen frame motion generation system further comprises:
a motor support plate assembly;
a motor, wherein said motor adjacently rests upon said motor support plate assembly and wherein said motor supplies the motion power source; and
a kinetic motion redistribution system.

4. The sifting apparatus of claim 3 further comprising an apparatus vertical support system comprising a plurality of vertical support members attached to said main frame and a plurality of crossing members.

5. The sifting apparatus of claim 4, further comprising a vertical height adjustment system and a mobility system.

6. The sifting apparatus of claim 5, wherein said vertical height adjustment system further comprises:
at least one vertical height adjustment member that passes through at least one member of said at least one vertical support member; and
at least one height locking member that passes through both at least one member of said at least one vertical height adjustment member and at least one member of said at least one vertical support member.

7. The sifting apparatus of claim 6, wherein said kinetic motion redistribution system further comprises:
at least one motor pulley member;
at least one pulley drive member;
at least one belt member wherein the ends of said at least one belt member is adjacently about said motor pulley member at first end and said pulley drive member at a second end;
at least one crank shaft member;
at least one connecting member;
a plurality of securing members;
at least one friction reduction assembly; at least one rotating member that passes through at least one member of said at least one pulley drive member, at least one member of said at least one crank shaft member, at least one member of said at least one friction reduction assembly and said plurality of securing members; and
at least one shock absorption member attached to one end of said rotating member.

8. The sifting apparatus of claim 7, wherein said mobility system further comprises:
at least one mobility member attached to at least one member of said at least one vertical support member; and
at least one gripping member attached to at least one member of said at least one vertical support member.

9. A multi-screener apparatus comprising:
a main frame;
a plurality of screen frame members;
a screen motion generation system;
a debris sifting and removal system comprising:
a plurality of screen members removably attached at a set of edges, to at least one member selected from said plurality of screen frame members, so that said screen member lies over but not adjacent to the surface of said plurality of screen frame members;
a debris screen substantially perpendicular and removably attached to said surface of said plurality of screen frame members;
a debris redirection member attached to said main frame; and
a plurality of screen frame vertical support members removably attached to at least one selected member of said plurality of screen frame members at a first end of said selected member and wherein said screen frame vertical support members are attached to said main frame at a second end.

10. The multi-screener apparatus of claim 9 further comprising a screen motion generation means comprising:
a motor support plate assembly;
a motor, wherein said motor adjacently rests upon said motor support plate assembly and wherein said motor supplies the motion power source; and
a kinetic motion redistribution means.

11. The multi-screener apparatus of claim 10 further comprising a plurality of leg members attached to said main frame and a plurality of crossing bar members attached to at least two members of said plurality of leg members.

12. The multi-screener apparatus of claim 11 further comprising:
at least one vertical height adjustment member that passes through at least one member of said plurality of leg members; and
at least one height locking member that passes through at least one member of said at least one vertical height adjustment member and passes through at least one member of said plurality of leg members.

13. The multi-screener apparatus of claim 12 further comprising:
at least one mobility member attached to at least one member of said plurality of leg members; and
at least one gripping member attached to at least one member of said plurality of leg members wherein said gripping member is located opposite said mobility member so as to allow for movement of said apparatus when the gripping member side of said apparatus is raised above its resting surface by gripping at least one member of said at least one gripping member and lifting said gripped member, thereby raising said apparatus and thereby freeing said mobility member to move along said surface when supplied with a directional force of kinetic energy.

14. The multi-screener apparatus of claim 13, wherein said motor further comprises a power source that comprises at least one member selected from the group consisting of electric power sources, fossil fuel based power sources and kinetic motion power sources.

15. The multi-screener apparatus of claim 14, wherein said kinetic motion redistribution means further comprises:
at least one motor pulley member;
at least one pulley drive member;
at least one belt member wherein the ends of said at least one belt member are disposed adjacently about said motor pulley member at a first end and said pulley drive member at a second end;
at least one crank shaft member;
at least one connecting member;
a plurality of securing members;
at least one friction reduction assembly;
at least one rotating member that passes through at least one member of said at least one pulley drive member, at least one member of said at least one crank shaft member, at least one member of said at least one friction reduction assembly and said plurality of securing members; and,
at least one shock absorption member attached to one end of said rotating member.

16. The multi-screener apparatus of claim 14, wherein said mobility system further comprises at least one mobility member attached to at least one member of said at least one vertical support member and at least one gripping member attached to at least one member of said at least one vertical support member.

17. A method of using a sifting apparatus comprising the steps of:
placing a plurality of materials onto a plurality of screen members for sifting, wherein said plurality of materials comprises:
a plurality of granular materials that may pass through said screen member;
a plurality of materials that will not pass through said screen member;
supplying a power source to said sifting apparatus; and
activating said apparatus sifting motion, wherein said sifting motion comprises a means for substantially eliminating kinetic motion transfer to the apparatus frame.

18. The method of using a sifting apparatus of claim 16, wherein said power source comprises at least one member selected from the group consisting of electric power sources, fossil fuel based power sources and kinetic motion power sources.

19. The method of using a sifting apparatus of claim 17, wherein said means for substantially eliminating kinetic motion transfer to said apparatus frame further comprises a means for moving the screen members of said plurality of screen members in opposing directions, wherein the opposing motion of said plurality of screen members substantially eliminates the kinetic motion to said apparatus frame.

20. The method of using a sifting apparatus of claim 18 further comprising the steps:
placing said apparatus in a desired location by a location placing method, wherein said location placing method comprises the steps of:
gripping a plurality of said apparatus by apparatus gripping members;
moving said apparatus by manually moving said apparatus to said desired location, wherein said manual moving is assisted by an apparatus movement means; and
returning said apparatus to rest after said manual moving to said desired location.
